(19) United States
(12) Patent Application Publication
(10) Pub. No.: US 2026/0038134 A1
(43) Pub. Date: Feb. 5, 2026

(54) DEPTH MAP COMPLETION METHOD AND APPARATUS, COMPUTER DEVICE, AND STORAGE MEDIUM

(71) Applicant: Tencent Technology (Shenzhen) Company Limited, Shenzhen (CN)

(72) Inventor: Keyang LUO, Shenzhen (CN)

(73) Assignee: Tencent Technology (Shenzhen) Company Limited, Shenzhen (CN)

(21) Appl. No.: 19/352,037

(22) Filed: Oct. 7, 2025

Related U.S. Application Data
(63) Continuation of application No. PCT/CN2024/113387, filed on Aug. 20, 2024.

(30) Foreign Application Priority Data
Oct. 20, 2023 (CN) 202311375449.1

(51) Int. Cl. G06T 7/50; G06V 10/80; G06V 10/82

(52) U.S. Cl. CPC G06T 7/50; G06V 10/803; G06V 10/82; G06T 2207/20081

(57) ABSTRACT

This application discloses a depth map completion method and apparatus, a computer device, and a storage medium, and relates to the field of artificial intelligence. The method includes: aggregating features of a scene image and a sparse depth map to obtain an aggregated feature; diffusing and completing the aggregated feature based on a diffusion strength parameter through a depth completion network to obtain a depth completion feature; and performing image restoration based on the depth completion feature to obtain a dense depth map.

### CROSS-REFERENCE TO RELATED APPLICATIONS

This application is a continuation of PCT/CN2024/113387, filed on Aug. 20, 2024, which claims priority to Chinese Patent Application No. 202311375449.1, filed on Oct. 20, 2023, both entitled “DEPTH MAP COMPLETION METHOD AND APPARATUS, COMPUTER DEVICE, AND STORAGE MEDIUM,” which are incorporated by reference in their entireties.

### TECHNOLOGICAL FIELD

This application relates to the field of artificial intelligence, and in particular, to a depth map completion method and apparatus, a computer device, and a storage medium.

### BACKGROUND OF THE DISCLOSURE

In the field of three-dimensional artificial intelligence generated content (AIGC), depth map completion is one of the fundamental tasks. Depth map completion refers to a process of completing a sparse depth map based on the sparse depth map and its associated scene image to obtain a dense depth map, where the dense depth map contains scene depth information of each pixel in the scene image.

In related technologies, neural network models are typically employed to achieve depth map completion. For example, through supervised learning, large amounts of scene-specific images and depth information are collected and calibrated. Then a neural network model is trained on calibrated data. And, subsequently, a trained neural network model is configured to complete other sparse depth maps in a scene.

However, training neural network models using supervised learning methods is prone to overfitting, thus resulting in poor depth completion quality.

### SUMMARY

Embodiments of this disclosure provide a depth map completion method, apparatus, a computer device, and a storage medium. The technical solutions are as follows:

According to one aspect, an embodiment of this disclosure provides a depth map completion method, the method being executed by a computer device and including:
aggregating features of a scene image and a sparse depth map to obtain an aggregated feature, the sparse depth map being a depth map with missing depth information corresponding to the scene image, and the aggregated feature undergoing noise addition processing through a noise;
diffusing and completing the aggregated feature based on a diffusion strength parameter through a depth completion network to obtain a depth completion feature, the depth completion network being based on a diffusion model, and the diffusion strength parameter being configured for controlling a reverse diffusion strength in a depth completion process; and
performing image restoration based on the depth completion feature to obtain a dense depth map, a depth information completeness of the dense depth map being higher than a depth information completeness of the sparse depth map.

According to another aspect, an embodiment of this disclosure provides a depth map completion apparatus, the apparatus including:
a feature aggregation module, configured to aggregate features of a scene image and a sparse depth map to obtain an aggregated feature, the sparse depth map being a depth map with missing depth information corresponding to the scene image, and the aggregated feature undergoing noise addition processing through a noise;
a depth completion module, configured to diffuse and complete the aggregated feature based on a diffusion strength parameter through a depth completion network to obtain a depth completion feature, the depth completion network being based on a diffusion model, and the diffusion strength parameter being configured for controlling a reverse diffusion strength in a depth completion process; and
an image restoration module, configured to perform image restoration based on the depth completion feature to obtain a dense depth map, a depth information completeness of the dense depth map being higher than a depth information completeness of the sparse depth map.

According to another aspect, an embodiment of this disclosure provides a computer device, including a processor and a memory, the memory having at least one computer instruction stored therein, the at least one computer instruction being loaded and executed by the processor to implement the depth map completion method according to the above aspect.

According to another aspect, an embodiment of this disclosure provides a computer-readable storage medium, having at least one computer instruction stored therein, the at least one computer instruction being loaded and executed by a processor to implement the depth map completion method according to the above aspect.

According to another aspect, an embodiment of this disclosure provides a computer program product, including computer instructions, the computer instructions being stored in a computer-readable storage medium, a processor of a computer device reading the computer instructions from the computer-readable storage medium, and the processor executing the computer instructions to cause the computer device to implement the depth map completion method according to the above aspect.

In the embodiments of this disclosure, by aggregating the features of the scene image and the sparse depth map, and performing noise addition processing through the noise to obtain the aggregated feature, and diffusing and completing the aggregated feature based on the diffusion strength parameter through the depth completion network, the depth completion feature for image restoration can be generated to obtain the dense depth map. By adopting the method according to the embodiment of this disclosure, a diffusion denoising process based on the diffusion model is incorporated into a depth completion task, thus reducing an overfitting risk of the depth completion network during training, and improving a robustness of the depth completion network in an inference stage, that is, improving a generation quality of the dense depth map.

### BRIEF DESCRIPTION OF THE DRAWINGS

In order to more clearly describe the technical solutions in the embodiments of this disclosure, the following will briefly introduce the drawings needed in the description of the embodiments. Clearly, the drawings in the following description are only some embodiments of this disclosure. Those skilled in the art may obtain other drawings from these drawings without contributing any inventive labor.

FIG. 1 is a structural block diagram of a computer system according to an exemplary embodiment of this disclosure.

FIG. 2 is a flowchart of a depth map completion method according to an exemplary embodiment of this disclosure.

FIG. 3 is a schematic diagram of a depth completion network according to an exemplary embodiment of this disclosure.

FIG. 4 is a schematic internal structural diagram of a residual layer ResBlock-D according to an exemplary embodiment of this disclosure.

FIG. 5 is a schematic internal structural diagram of a residual layer ResBlock-U according to an exemplary embodiment of this disclosure.

FIG. 6 is a schematic diagram of a process of diffusing and completing an aggregated feature through a depth completion network via N-round iterations according to an exemplary embodiment of this disclosure.

FIG. 7 is a flowchart of training a depth completion network according to an exemplary embodiment of this disclosure.

FIG. 8 is a structural block diagram of a depth map completion apparatus according to an exemplary embodiment of this disclosure.

FIG. 9 is a schematic structural diagram of a computer device according to an exemplary embodiment of this disclosure.

### DETAILED DESCRIPTION

To make the objectives, technical solutions, and advantages of this disclosure clearer, the following further describes the implementations of this disclosure in detail with reference to the accompanying drawings.

In the field of three-dimensional AIGC, depth map completion is one of fundamental tasks. Depth map completion refers to a process of completing a sparse depth map based on the sparse depth map and its associated scene image to obtain a dense depth map, where the dense depth map contains scene depth information of each pixel in the scene image.

In related technologies, neural network models are typically employed to achieve depth map completion. For example, through supervised learning, large amounts of scene-specific images and depth information are collected and calibrated; then a neural network model is trained on calibrated data, and subsequently, a trained neural network model is configured to complete other sparse depth maps in a scene.

However, training neural network models using supervised learning methods is prone to overfitting, thus resulting in a poor depth completion quality.

This disclosure provides a depth map completion method based on a diffusion model, which can improve a completion quality of the depth map.

The depth map completion method provided in this disclosure may be applied to multiple disclosure scenarios related to depth perception, including, but not limited to, the following scenarios:
1. Three-dimensional modeling field. The depth map completion method provided in this disclosure may be used for completing depth maps acquired by various depth perception devices (such as laser radar and depth cameras), and may also complete depth maps obtained through computation by using multi-view depth algorithms, thus improving a depth perception completeness and improving a modeling quality of three-dimensional models.
2. Autonomous driving field. The depth map completion method provided in this disclosure may be used for completing scene depth perceived by vehicle-mounted devices, thus improving an ability of autonomous driving algorithms to comprehensively perceive the surrounding environment and make more effective driving decisions.
3. Augmented reality field. The depth map completion method provided in this disclosure may be used for improving depth estimation results for real scenes, thus enabling better understanding of a relative relationship between real scenes and virtual objects in the current viewpoint, and improving the user experience.
4. 3D printing field. The depth map completion method provided in this disclosure may be used for better perceiving depth information of target objects, thus completely capturing details of objects-to-be-printed, and improving a quality of printed models.

In some embodiments, the depth map completion method provided in this disclosure may be applied to single-vision depth map completion tasks, so as to complete sparse depth maps corresponding to single-vision scene images. Single-vision depth map completion may also be referred to as monocular depth estimation, which refers to using a single scene image from a unique viewpoint to estimate a distance of each pixel in the scene image relative to the capturing source.

The depth map completion method provided in this disclosure may also be applied to gaming business scenarios, such as in augmented reality (AR) games or virtual reality (VR) games. To enhance a sense of augmented reality, users may use VR or AR devices to scan real environments, and the devices construct virtual environments in the game based on the environmental scanning results. Since constructing virtual environments requires depth information of the environment, when VR or AR devices can only obtain sparse depth maps based on the environmental scanning results, the depth map completion method provided in this disclosure may be adopted, which performs depth map completion based on sparse depth maps and environmental images captured during scanning, thus constructing virtual environments based on dense depth maps.

Please refer to FIG. 1, which shows a structural block diagram of a computer system according to an exemplary embodiment of this disclosure. The computer system may include a terminal 110 and a server 120. Data communication between the terminal 110 and the server 120 is carried out through a communication network. In some embodiments, the communication network may be a wired network or a wireless network, and the communication network may be at least one of a local area network, a metropolitan area network, and a wide area network.

The terminal 110 is an electronic device installed with an application program that has a depth map completion function, and this depth map completion function is implemented based on a depth completion network by performing depth completion tasks. The depth map completion function may be a native application function or the third-party application function in the terminal 110; The terminal 110 may be a smart phone, a tablet, a laptop, a desktop computer, a smart TV, a wearable device, a vehicle-mounted terminal, or the like. FIG. 1 illustrates only by taking the terminal 110 being a desktop computer as an example, which is not limited thereto.

The server 120 includes at least one of one server, multiple servers, a cloud computing platform, and a virtualization center. In this embodiment of this disclosure, the server 120 may be a backend server of an application program with a depth map completion function, and the server 120 stores a depth completion network and related network parameters.

In some embodiments, there is data exchange between the server and the terminal. Schematically, as shown in FIG. 1, the terminal 110 acquires a scene image and a sparse depth map corresponding to the scene image, and then transmits the scene image and the sparse depth map to the server 120. The server 120 aggregates features of the sparse depth map and the scene image, and performs noise addition processing through a noise to obtain an aggregated feature. Subsequently, the server 120 diffuses and completes the aggregated feature based on a diffusion strength parameter through a depth completion network to obtain a depth completion feature, then performs image restoration based on the depth completion feature to obtain a dense depth map corresponding to the scene image, and finally returns the dense depth map to the terminal 110.

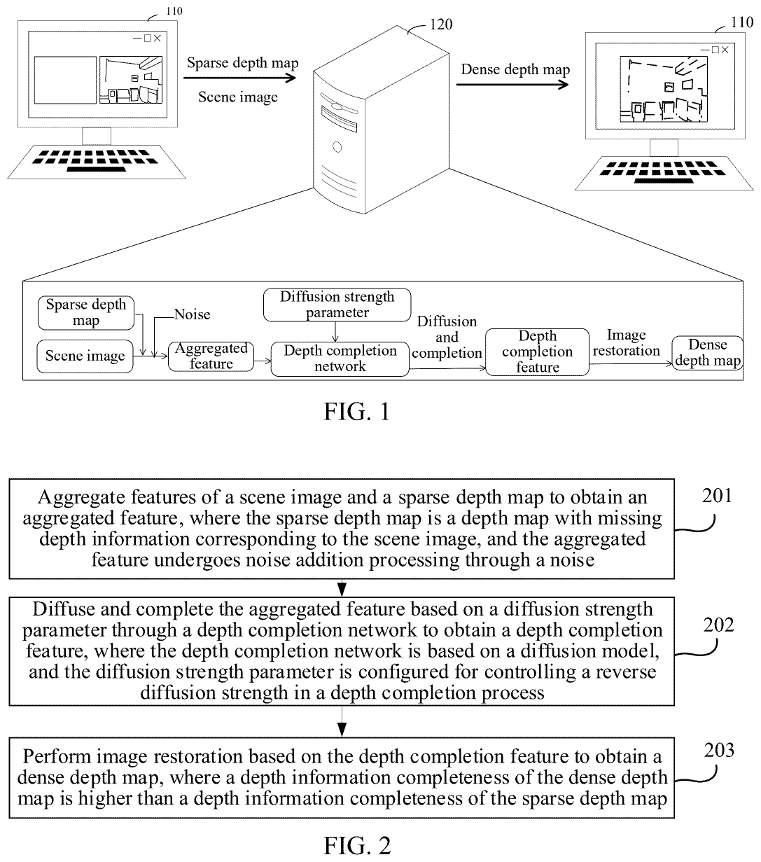

Referring to FIG. 2, FIG. 2 is a flowchart of a depth map completion method according to an exemplary embodiment of this disclosure. Description will be made in this embodiment by taking the method for a computer device (including terminal and/or server) as an example. The method includes the following operations:

Operation 201: Aggregate features of a scene image and a sparse depth map to obtain an aggregated feature, where the sparse depth map is a depth map with missing depth information corresponding to the scene image, and the aggregated feature undergoes noise addition processing through a noise.

The scene image is an original image configured for computing a corresponding depth map. In some embodiments, the scene image is a red green blue (RGB) three-channel color image.

In some embodiments, the scene image is an image obtained by an image acquisition device (such as camera) by photographing.

In some embodiments, the scene image is an image obtained through preprocessing or various computations.

The sparse depth map is a depth map with missing depth information corresponding to the scene image. That is, the sparse depth map only contains depth information of some pixels.

Exemplarily, the scene image is an RGB image with a resolution of (H, W), where H is pixel height and W is pixel width. The sparse depth map corresponding to the scene image is a depth map with a resolution of (H, W), but the sparse depth map only contains depth information of some pixels in the scene image, that is, the depth information corresponding to some pixels in the scene image is missing in the sparse depth map.

In some embodiments, the sparse depth map is a depth map acquired by a depth perception device (such as laser radar, depth cameras). Due to the limitations of physical hardware, factors such as surface reflections of smooth objects, semi-transparent or transparent objects, dark-colored objects, and exceeding the measurement range may cause missing depth information in the depth map acquired by the depth perception device.

In some embodiments, the sparse depth map may also be a depth map with some missing depth information obtained through preprocessing or various computations.

In some embodiments, the computer device encodes the scene image and the sparse depth map respectively to obtain a scene feature corresponding to the scene image and a sparse depth feature corresponding to the sparse depth map, then aggregates the scene feature and the sparse depth feature, and performs noise addition processing through the noise to obtain an aggregated feature.

In some embodiments, the noise may be obtained by randomly sampling Gaussian noise or other types of noise. In some embodiments, the computer device may sample Gaussian noise based on an image size of the sparse depth map to obtain a noisy image with a resolution of (H, W), and a value ε of each pixel in the noisy image is randomly determined based on a Gaussian distribution with a mean value of 0 and a standard deviation of 1. That is, ε˜G(0,1).

In some other embodiments, the computer device may also aggregate image features through other modes, for example, by firstly fusing the scene image and the sparse depth map, and performing encoding and noise addition on a fused image to obtain the aggregated feature. The specific mode of aggregating the features is not limited in this embodiment of this disclosure.

In some other embodiments, the computer device may also adopt a feature aggregation model that contains a convolutional neural network (CNN). By inputting the scene image and the sparse depth map into the feature aggregation model, an aggregated feature outputted by the feature aggregation model and undergoing noise addition processing is directly obtained.

Exemplarily, a feature resolution of the aggregated feature obtained through feature aggregation processing is (H, W).

Operation 202: Diffuse and complete the aggregated feature based on a diffusion strength parameter through a depth completion network to obtain a depth completion feature, where the depth completion network is based on a diffusion model, and the diffusion strength parameter is configured for controlling a reverse diffusion strength in a depth completion process.

The depth completion network is configured for performing depth completion processing on the aggregated feature, so that the output depth completion feature can be configured for restoring to obtain a depth map containing more depth information.

In some embodiments, the depth completion network may be a depth completion network based on a diffusion model, also known as a DiffDC network.

The diffusion model, also known as a denoising diffusion probabilistic model (DDPM), is a model that can be configured for implementing artificial intelligence content generation. The theoretical basis of the algorithm of the diffusion model is to train a parameterized Markov chain through variational inference.

A training process of the diffusion model includes two stages, namely a forward diffusion process and a reverse diffusion process.

The forward diffusion process is configured for giving an initial data distribution and continuously adding Gaussian noise to the distribution. The forward diffusion process is a Markov process.

The reverse diffusion process is configured for continuously restoring the noise to initial data, predicting the noise added at each operation through the reverse diffusion process, and gradually restoring a noise-free image by removing the noise.

In some embodiments, the diffusion strength parameter refers to a parameter configured for controlling a reverse diffusion strength in the depth completion process. That is, the computer device may adjust a denoising strength of each operation in the reverse diffusion process by setting different diffusion strength parameters. In some embodiments, the diffusion strength parameter may be a fixed value preset before depth completion, or a value dynamically adjusted based on the depth completion progress in the depth completion process, which is not limited in this embodiment of this disclosure. Exemplarily, the diffusion strength parameter t may be randomly determined based on a (0,1) uniform distribution. That is, t˜U(0,I).

In some embodiments, after obtaining the aggregated feature, the computer device diffuses and completes the aggregated feature based on the diffusion strength parameter through the depth completion network to obtain a depth completion feature corresponding to the sparse depth map.

Operation 203: Perform image restoration based on the depth completion feature to obtain a dense depth map, where a depth information completeness of the dense depth map is higher than a depth information completeness of the sparse depth map.

In a possible implementation, the computer device may perform image restoration through a neural network model based on the depth completion feature to obtain a dense depth map. For example, the computer device inputs the depth completion feature into the CNN, and the CNN learns and extracts the depth completion feature to generate a dense depth map.

In some embodiments, the depth information completeness of the dense depth map is higher than the depth information completeness of the sparse depth map, that is, a number of pixels with depth information in the dense depth map is greater than a number of pixels with depth information in the sparse depth map.

Exemplarily, depth information of 1000 pixels is missing in the sparse depth map, while depth information of only 500 pixels or 300 pixels is missing in the dense depth map, or the dense depth map contains depth information of each pixel.

In some embodiments, the computer device may further gradually complete the depth information of pixels in the sparse depth map through multi-round iterations, that is, gradually obtain a dense depth map with a higher depth information completeness through multi-round iterations. The more the iterations, the higher the depth information completeness of the dense depth map.

To sum up, by aggregating the features of the scene image and the sparse depth map, and performing noise addition processing through the noise to obtain an aggregated feature, and diffusing and completing the aggregated features based on the diffusion strength parameter through the depth completion network, the depth completion feature for image restoration can be generated to obtain the dense depth map. By adopting the method according to the embodiment of this disclosure, a diffusion denoising process based on the diffusion model is incorporated into a depth completion task, thus reducing an overfitting risk of the depth completion network during training, and improving a robustness of the depth completion network in an inference stage, that is, improving a generation quality of the dense depth map.

In regard to the mode of obtaining the aggregated feature, in some embodiments, the computer device may perform encoding on the features of the sparse depth map and the scene image respectively, and then perform noise addition to an encoded feature to obtain the aggregated feature. This process includes the following operations:

Operation 1: Encode a feature of the sparse depth map through the first encoder to obtain a sparse depth feature.

In some embodiments, the computer device may encode the feature of the sparse depth map through the first encoder to obtain a sparse depth feature.

In some embodiments, the first encoder may be an encoder with a CNN structure, an auto-encoder, a Transformer encoder, or any other encoder capable of encoding the image feature, which is not limited in this embodiment of this disclosure.

In some embodiments, the first encoder is an encoder with a CNN structure, and the first encoder includes two convolutional neural network layers and a nonlinear activation function. The number of convolutional kernels in the first CNN layer and the second CNN layer may be the same or different. For example, the first CNN layer includes 32 1×1 convolutional kernels, and the second CNN layer includes 32 3×3 convolutional kernels.

In some embodiments, an image resolution of the sparse depth map may be (H, W), and the sparse depth map is a single-channel image that only contains depth information of pixels.

Exemplarily, the computer device encodes a sparse depth map Dₛₚₐᵣₛₑ with a resolution of (H, W) into a sparse depth feature Fₛ through the first encoder, and a calculation process may be represented as the following formula:

$${F}_{s} = {CNN}_{2}^{s} ( SiLU ( {CNN}_{1}^{s} ( {D}_{sparse} ) ) ) ,$$

where SiLU is an activation function, CNN₁^{s} is a two-dimensional 1×1 convolutional operation, with the number of input channel being 1 and the number of output channels being 32, and CNN₂^{s} is a two-dimensional 3×3 convolutional operation, with the number of input channel being 32 and the number of output channels being 32.

Operation 2: Encode a feature of the scene image through the second encoder to obtain a scene feature.

In some embodiments, the computer device may encode the feature of the scene image through the second encoder to obtain a scene feature.

In some embodiments, the second encoder may be an encoder with a CNN structure, an auto-encoder, a Transformer encoder, or any other encoder capable of encoding the image feature, which is not limited in this embodiment of this disclosure.

In some embodiments, the second encoder is an encoder with a CNN structure, and the second encoder includes two convolutional neural network layers and a nonlinear activation function. The number of convolutional kernels in the first CNN layer and the second CNN layer may be the same or different. For example, the first CNN layer and the second CNN layer both include 32 3×3 convolutional kernels.

In some embodiments, in order to improve an image data processing efficiency, before encoding the scene image through the second encoder, the computer device may firstly perform normalization processing on the pixel value of each pixel in the scene image, and then encode the feature of the scene image after normalization processing by using the second encoder.

In some embodiments, the image resolution of the scene image may be (H,W), and the scene image is a three-channel image, including RGB three channels. In some embodiments, the pixel value of each pixel in the scene image is between 0 and 255.

Exemplarily, the computer device encodes a scene image I_{ref} with a resolution of (H,W) into a scene feature Fᵣ through the second encoder, and a calculation process may be represented as the following formula:

$${F}_{r} = {CNN}_{2}^{r} ( SiLU ( {CNN}_{1}^{r} ( {I}_{ref} / 255. ) ) ) ,$$

where I_{ref}/255.0 represents normalization processing on the pixel value of the scene image and scaling the pixel value within a range of 0-1, CNN₁^{r} is a two-dimensional 3×3 convolutional operation, with the number of input channels being 3 and the number of output channels being 32, and CNN₂^{r} is a two-dimensional 3×3 convolutional operation, with the number of input channels being 32 and the number of output channels being 32.

Operation 3: Aggregate the scene feature and the sparse depth feature, and perform noise addition processing through a noise to obtain an aggregated feature, where dimensions of the scene feature, the sparse depth feature, and the noise are consistent.

In some embodiments, after obtaining the sparse depth feature corresponding to the sparse depth map and the scene feature corresponding to the scene image, the computer device may aggregate the scene feature and the sparse depth features, and then performs noise addition processing through the noise to obtain the aggregated feature.

Dimensions of the scene feature, the sparse depth feature, and the noise are consistent. In some embodiments, resolutions and channel dimensions of the scene feature, the sparse depth feature, and the noise are consistent. Exemplarily, the resolution of the scene feature is H×W, and the channel dimension is 32; the resolution of the sparse depth feature is H×W, and the channel dimension is 32; the resolution of the noise is H×W, and the channel dimension is 32.

In some embodiments, the computer device may firstly stitch the scene feature, the sparse depth feature, and the noise, and then perform a convolutional operation to obtain an aggregated feature.

In some embodiments, the computer device may firstly stitch the sparse depth feature Fₛ, the scene feature Fᵣ, and the noise X_{g} to obtain a tensor F_{raw}=Concatenate(X_{g}, Fᵣ, Fₛ), and then perform a convolutional operation to obtain the aggregated feature

$${F}_{in}^{0} :$$

$${F}_{in}^{0} = SiLU ( CNN ( {F}_{raw} ) ) ,$$

where the resolution of the aggregated feature

$${F}_{in}^{0}$$

is (H, W), and the number of feature channels is 64.

Those skilled in the art can understand that the above descriptions of the first encoder, the second encoder, and the feature aggregation mode are only exemplary, and other reasonable feature encoding modes may also be adopted to encode and aggregate the scene image and the sparse depth map. For example, the two-dimensional 1×1 convolutional operation in the first encoder may be replaced with a multi-layer perceptron or transformer structure, the second encoder may be replaced with any image pre-training large model, and such variations are still within the scope of protection of this disclosure.

In some embodiments, the depth completion network includes a downsampling diffusion subnetwork and an upsampling diffusion subnetwork. In order to extract depth information from the aggregated feature, the computer device may firstly perform downsampling diffusion on the aggregated feature to obtain a downsampling depth feature, and then perform upsampling diffusion on the downsampling depth feature to obtain a depth completion feature. The process includes the following operations:

Operation 1: Perform downsampling diffusion on an aggregated feature based on a diffusion strength parameter through a downsampling diffusion subnetwork to obtain a downsampling depth feature.

In some embodiments, the computer device may perform downsampling diffusion on the aggregated feature based on the diffusion strength parameter through the downsampling diffusion subnetwork to obtain a downsampling depth feature. In some embodiments, in a case that the resolution of the aggregated feature is H×W and the channel dimension is 64, the resolution of the downsampling depth feature may be (H/8, W/8) and the channel dimension may be 256.

In some embodiments, in order to improve the downsampling accuracy and acquire more effective image features, the computer device may also configure multiple downsampling layers in the downsampling diffusion subnetwork for level-by-level downsampling diffusion on the aggregated feature.

In some embodiments, the downsampling diffusion subnetwork includes n downsampling layers, where n is a positive integer.

Exemplarily, in a case that n=4, the downsampling diffusion subnetwork performs downsampling diffusion on the aggregated feature level by level through four downsampling layers. Resolution levels are respectively (H, W), (H/2, W/2), (H/4, W/4), and (H/8, W/8). The convolutional feature dimensions (number of channels) corresponding to different resolution levels are respectively 64, 128, 128, 256.

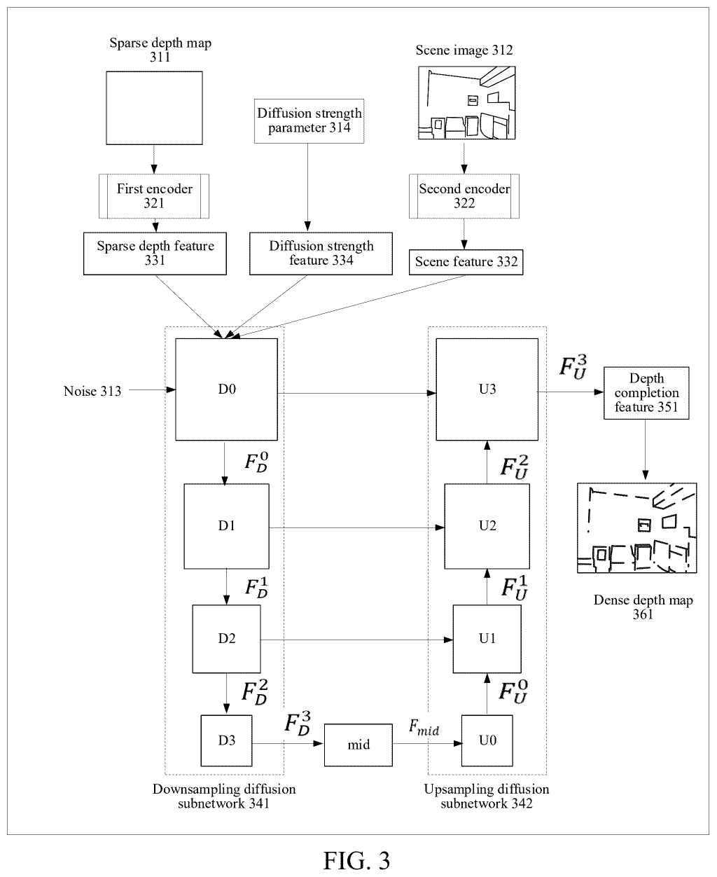

Referring to FIG. 3, FIG. 3 is a schematic diagram of a depth completion network according to an exemplary embodiment of this disclosure.

As shown in FIG. 3, the depth completion network includes a downsampling diffusion subnetwork 341. The downsampling diffusion subnetwork 341 includes n downsampling layers (n=4), respectively including downsampling layers D0, D1, D2, and D3.

In regard to the process of performing downsampling diffusion on the aggregated feature through the downsampling diffusion subnetwork to obtain the downsampling depth feature, in some embodiments, the computer device may perform downsampling processing on the aggregated feature sequentially through the n downsampling layers.

In some embodiments, the computer device may perform downsampling diffusion on the aggregated feature based on the diffusion strength parameter through the first downsampling layer to obtain the first downsampling feature, then perform downsampling diffusion on an i^{th} downsampling feature based on the diffusion strength parameter through an (i+1)^{th} downsampling layer to obtain an (i+1)^{th} downsampling feature, and finally use an n^{th} downsampling feature outputted by an n^{th} downsampling layer as the downsampling depth feature.

Schematically, as shown in FIG. 3, the computer device may encode a sparse depth map 311 through the first encoder 321 to obtain a sparse depth feature 331, encode a scene image 312 through the second encoder 322 to obtain a scene feature 332, and aggregate the sparse depth feature 331 and the scene feature 332, and perform noise addition processing through a noise 313 to obtain an aggregated feature, and the aggregated feature serves as an input of the first downsampling layer DO in the downsampling diffusion subnetwork 341.

In some embodiments, the input of the downsampling diffusion subnetwork further includes an encoded diffusion strength parameter. Schematically, as shown in FIG. 3, the computer device encodes the feature of the diffusion strength parameter 314 to obtain a diffusion strength feature 334, and uses the diffusion strength feature 334 as the input of the first downsampling layer DO in the downsampling diffusion subnetwork 341.

The mode of encoding of the diffusion strength parameter t to obtain the diffusion strength feature Fₜ may be represented as the following formula. Firstly, the diffusion strength parameter t is expanded into the following high-dimensional vector Eₜ(t):

$${E}_{t} ( t ) = \{ sin ( t \cdot {e}^{0} ) , cos ( t \cdot {e}^{0} ) , sin ( t \cdot {e}^{δ} ) , cos ( t \cdot {e}^{δ} ) , ⋯ , cos ( t \cdot {e}^{31 δ} ) \} ,$$

where δ=−0.28782, sin and cos are respectively a sine function and a cosine function, and Eₜ(t) is a 64-dimension feature vector.

Then, a high-dimensional diffusion strength feature Fₜ is obtained through two layers of linear neural networks:

$${F}_{t} = {linear}_{2} ( SiLU ( {linear}_{1} ( {E}_{t} ( t ) ) ) ) ,$$

where linear₁ and linear₂ are respectively linear neural networks of R⁶⁴→R²⁵⁶ and R²⁵⁶→R²⁵⁶.

Those skilled in the art can understand that the above mode of encoding the diffusion strength parameter is only exemplary, and other reasonable feature encoding modes may also be used to encode the diffusion strength parameter. For example, the linear neural networks may be replaced with transformer structures, or the sin and cos function may be replaced with other basis functions (such as spherical harmonic functions), and such variations are still within the scope of protection of this disclosure.

The process of obtaining the downsampling depth feature will be described below by taking the downsampling diffusion subnetwork 341 including four downsampling layers as an example.

In some embodiments, the computer device may perform downsampling diffusion on the aggregated feature based on the diffusion strength parameter through the first downsampling layer to obtain the first downsampling feature.

For example, the computer device inputs the diffusion strength feature 334 and the aggregated feature (obtained by aggregating the sparse depth feature 331 and the scene feature 332 and performing noise addition processing through the noise 313) into the first downsampling layer D0 to obtain the first downsampling feature

$${F}_{D}^{0}$$

outputted by D0.

Exemplarily, the first downsampling layer D0 performs 1× downsampling, and the first downsampling feature

$${F}_{D}^{0}$$

outputted by the first downsampling layer D0 is a feature vector with a resolution of (H, W) and the number of feature channels of 64.

In some embodiments, the computer device may perform downsampling diffusion on an i^{th} downsampling feature based on the diffusion strength parameter through an (i+1)^{th} downsampling layer to obtain an (i+1)^{th} downsampling feature.

Exemplarily, i=1, 2, or 3.

For example, the computer device inputs the first downsampling feature

$${F}_{D}^{0}$$

and the diffusion strength feature 334 into the second downsampling layer D1, and the second downsampling layer D1 performs downsampling diffusion on the first downsampling feature

$${F}_{D}^{0}$$

based on the diffusion strength feature 334 to obtain the second downsampling feature

$${F}_{D}^{1} .$$

Exemplarily, the second downsampling layer D1 performs 2× downsampling, and the second downsampling feature

$${F}_{D}^{1}$$

is a feature vector with a resolution of (H/2, W/2) and the number of feature channels of 128.

Further, the computer device inputs the second downsampling feature

$${F}_{D}^{1}$$

into the third downsampling layer D2, and the third downsampling layer D2 performs downsampling diffusion on the second downsampling feature

$${F}_{D}^{1}$$

to obtain the third downsampling feature

$${F}_{D}^{2} .$$

Exemplarily, the third downsampling layer D2 performs 2× downsampling, and the third downsampling feature

$${F}_{D}^{2}$$

is a feature vector with a resolution of (H/4, W/4) and the number of feature channels of 128.

Finally, the computer device inputs the third downsampling feature

$${F}_{D}^{2}$$

into the fourth downsampling layer D3, and the fourth downsampling layer D3 performs downsampling diffusion on the third downsampling feature,

$${F}_{D}^{2}$$

to obtain the fourth downsampling feature

$${F}_{D}^{3} ,$$

and the computer device uses the fourth downsampling feature

$${F}_{D}^{3}$$

as the downsampling depth feature.

Exemplarily, the fourth downsampling layer D3 performs 2× downsampling, and the fourth downsampling feature

$${F}_{D}^{3}$$

is a feature vector with a resolution of (H/8, W/8) and the number of feature channels of 256.

Operation 2: Performing upsampling diffusion on the downsampling depth feature based on the diffusion strength parameter through an upsampling diffusion subnetwork to obtain a depth completion feature.

In some embodiments, the computer device may perform upsampling diffusion on the downsampling depth feature based on the diffusion strength parameter through the upsampling diffusion subnetwork to obtain a depth completion feature. In some embodiments, in a case that the resolution of the aggregated feature is H×W, and the channel dimension is 64; and the resolution of the downsampling depth feature is (H/8, W/8), and the channel dimension is 256, the resolution of the depth completion feature obtained through upsampling diffusion may be H×W, and the channel dimension may be 64.

In some embodiments, in order to improve upsampling accuracy and acquire more effective image features, the computer device may also configure multiple upsampling layers in the upsampling diffusion subnetwork for level-by-level upsampling diffusion on the downsampling depth feature.

In some embodiments, the number of the upsampling layers contained in the upsampling diffusion subnetwork may be the same as the number of the downsampling layers contained in the downsampling diffusion subnetwork, that is, the upsampling layers also include n upsampling layers.

Exemplarily, in a case that n=4, the upsampling diffusion subnetwork performs upsampling diffusion on the downsampling depth feature level by level through four upsampling layers. Resolution levels are respectively (H/8, W/8), (H/4, W/4), (H/2, W/2), and (H,W). The convolutional feature dimensions (number of channels) corresponding to different resolution levels are respectively 256, 128, 128, and 64.

Schematically, as shown in FIG. 3, the depth completion network includes an upsampling diffusion subnetwork 342. The upsampling diffusion subnetwork 342 includes n upsampling layers (n=4), respectively including upsampling layers U0, U1, U2, and U3.

In some embodiments, the computer device may perform upsampling diffusion on the downsampling depth feature based on the diffusion strength parameter through the first upsampling layer to obtain the first upsampling feature, then perform upsampling diffusion on an i^{th} upsampling feature based on the diffusion strength parameter through an (i+1)^{th} upsampling layer to obtain an (i+1)^{th} upsampling feature, and finally use an n^{th} upsampling feature outputted by an n^{th} upsampling layer as the depth completion feature.

In some embodiments, in order to further extract the depth feature, before using the upsampling diffusion subnetwork to process the downsampling depth feature, the computer device may also configure a bottleneck encoding subnetwork between the downsampling diffusion subnetwork and the upsampling diffusion subnetwork. The bottleneck encoding subnetwork is firstly configured for performing bottleneck encoding on the downsampling depth feature, and then an encoded feature is inputted into the upsampling diffusion subnetwork to optimize the sampling process and reduce the risk of overfitting.

In some embodiments, the resolution of the input feature of the bottleneck encoding subnetwork is (H/8, W/8), and the number of feature channels is 256; and the resolution of the output feature is (H/8, W/8), and the number of feature channels is 256. That is, the bottleneck encoding subnetwork does not change the resolution of the feature and the number of channels.

Schematically, as shown in FIG. 3, the depth completion network includes a bottleneck encoding subnetwork mid, and the bottleneck encoding subnetwork mid is located between the downsampling diffusion subnetwork 341 and the upsampling diffusion subnetwork 342.

In some embodiments, the computer device may input the fourth downsampling feature

$${F}_{D}^{3}$$

outputted by th fourth downsampling layer D3 into the bottleneck encoding subnetwork mid to obtain an output result F_{mid}.

The process of obtaining the depth completion feature will be described below by taking the upsampling diffusion subnetwork 342 including four upsampling layers as an example.

In some embodiments, the computer device may perform upsampling diffusion on the downsampling depth feature based on the diffusion strength parameter through the first upsampling layer to obtain the first upsampling feature.

For example, the computer device inputs the diffusion strength feature 334 and F_{mid} inputted based on the downsampling depth feature

$${F}_{D}^{3}$$

into the first upsampling layer U0, and the first upsampling layer U0 performs upsampling diffusion F_{mid} to obtain the first upsampling feature

$${F}_{U}^{0} .$$

Exemplarily, the first upsampling layer U0 performs 2× upsampling, and the first upsampling feature

$${F}_{U}^{0}$$

is a feature vector with a resolution of (H/4, W/4) and the number of feature channels of 128.

In some embodiments, the computer device may perform upsampling diffusion on an i^{th} upsampling feature based on the diffusion strength parameter through an (i+1)^{th} upsampling layer to obtain an (i+1)^{th} upsampling feature.

Exemplarily, i=1, 2, or 3.

For example, the computer device inputs the first upsampling feature

$${F}_{U}^{0}$$

and the diffusion strength feature 334 into the second upsampling layer U1, and the second upsampling layer U1 performs upsampling diffusion on the first upsampling feature

$${F}_{U}^{0}$$

to obtain the second upsampling feature

$${F}_{U}^{1} .$$

Exemplarily, the second upsampling layer U1 performs 2× upsampling, and the second upsampling feature

$${F}_{U}^{1}$$

is a feature vector with a resolution of (H/2, W/2) and the number of feature channels of 128.

Further, the computer device inputs the second upsampling feature

$${F}_{U}^{1}$$

into the third upsampling layer U2, and the third upsampling layer U2 performs upsampling diffusion on the second upsampling feature

$${F}_{U}^{1}$$

to obtain the third upsampling feature

$${F}_{U}^{2} .$$

Exemplarily, the third upsampling layer U2 performs 2× upsampling, and the third upsampling feature

$${F}_{U}^{2}$$

is a feature vector with a resolution of (H, W) and the number of feature channels of 64.

Finally, the computer device inputs the third upsampling feature

$${F}_{U}^{2}$$

into the fourth upsampling layer U3, and the fourth upsampling layer U3 performs upsampling diffusion on the third upsampling feature

$${F}_{U}^{2}$$

to obtain the fourth upsampling feature

$${F}_{U}^{3} ,$$

and the computer device uses the fourth upsampling feature

$${F}_{U}^{3}$$

as the depth completion feature.

Exemplarily, the fourth upsampling layer U0 performs 1× upsampling, and the fourth upsampling feature

$${F}_{U}^{3}$$

is a feature vector with a resolution of (H, W) and the number of feature channels of 64.

In some embodiments, the computer device may perform image restoration based on the depth completion feature

$${F}_{U}^{3}$$

351 to obtain a dense depth map 361, where a depth information completeness of the dense depth map 361 is higher than a depth information completeness of the sparse depth map 311.

In some embodiments, the image resolution of the dense depth map may be (H, W), and the dense depth map is a single-channel image that only contains depth information of pixels.

Exemplarily, the process of performing image restoration based on the depth completion feature

$${F}_{U}^{3}$$

351 to obtain a dense depth map 361 may be implemented through a single two-dimensional convolutional operation, and the formula is as follows:

$$CNN ( {F}_{U}^{0} ) .$$

In some embodiments, in order to fuse feature information of different scales, before upsampling diffusion, the computer device may firstly fuse the i^{th} upsampling feature and an (n−i)^{th} downsampling feature to obtain an i^{th} fused feature, and then perform upsampling diffusion on the i^{th} fused feature based on the diffusion strength parameter through the (i+1)^{th} upsampling layer to obtain an (i+1)^{th} upsampling feature.

Exemplarily, i=1, 2, or 3.

For example, the computer device firstly fuses the first upsampling feature

$${F}_{U}^{0}$$

and the third downsampling feature

$${F}_{D}^{2}$$

to obtain the first fused feature

$${F}_{U}^{0} ⊕ {F}_{D}^{2} ;$$

and then perform upsampling diffusion on the first fused feature based on the diffusion strength parameter through the second upsampling layer U1 to obtain the second upsampling feature

$${F}_{U}^{1} .$$

Further, the computer device fuses the second upsampling feature

$${F}_{U}^{1}$$

and the second downsampling feature

$${F}_{D}^{1}$$

to obtain the second fused feature

$${F}_{U}^{1} ⊕ {F}_{D}^{1} ;$$

and then perform upsampling diffusion on the second fused feature based on the diffusion strength parameter through the third upsampling layer U2 to obtain the third upsampling feature

$${F}_{U}^{2} .$$

Finally, the computer device fuses the third upsampling feature

$${F}_{U}^{2}$$

and the first downsampling feature

$${F}_{D}^{0}$$

to obtain third fused feature

$${F}_{U}^{2} ⊕ {F}_{D}^{0} ;$$

and then perform upsampling diffusion on the third fused feature based on the diffusion strength parameter through the fourth upsampling layer U3 to obtain fourth upsampling feature

$${F}_{U}^{3} .$$

In this embodiment, by configuring multiple downsampling layers in the downsampling diffusion subnetwork to perform downsampling on the aggregated feature layer by layer, and configuring multiple upsampling layers in the upsampling diffusion subnetwork to perform upsampling on the downsampling depth feature layer by layer, the sampling accuracy is improved, thus helping to fully extract the image feature.

In addition, in the upsampling process, by fusing the i^{th} upsampling feature and the (n−i)^{th} downsampling feature to obtain the i^{th} fused feature and then performing upsampling on the i^{th} fused feature, the upsampling layers in the upsampling diffusion subnetwork can learn feature information of different scales, thus improving the depth completion effect.

The sampling diffusion process of each downsampling layer in the downsampling diffusion subnetwork and each upsampling layer in the upsampling diffusion subnetwork will be described below through embodiments.

In some embodiments, each of the downsampling layers, the upsampling layers, and the bottleneck encoding subnetwork mid includes a residual layer ResBlock (Residual Block), an attention layer Attention, and a residual layer ResBlock that are sequentially connected.

Based on the difference in sampling operations of the sampling layer (Sample) in the residual layer ResBlock, the residual layer ResBlock may be further divided into three types, i.e., ResBlock-D, ResBlock-I, and ResBlock-U. In a case that the Sample operation is downsampling, the corresponding ResBlock is ResBlock-D; in a case that the Sample operation is upsampling, the corresponding ResBlock is ResBlock-U; and in a case that the Sample operation is identity mapping, that is, no sampling operation is performed, the corresponding ResBlock is ResBlock-I.

Exemplarily, the downsampling layer D0 and the upsampling layer U3 sequentially include a residual layer ResBlock-I, an attention layer Attention, and a residual layer ResBlock-I.

Exemplarily, the downsampling layers D1, D2, and D3 sequentially include a residual layer ResBlock-D, an attention layer Attention, and a residual layer ResBlock-I.

Exemplarily, the upsampling layers U0, U1, and U2 sequentially include a residual layer ResBlock-U, an attention layer Attention, and a residual layer ResBlock-I.

In the downsampling process, the residual layer ResBlock-D is configured for fusing the i^{th} downsampling feature and the diffusion strength feature through skip connection.

In regard to the downsampling diffusion process of a single downsampling layer, in some embodiments, the computer device may perform downsampling on the i^{th} downsampling feature to obtain a downsampling intermediate feature, and fuse the diffusion strength feature and the downsampling intermediate feature to generate a downsampling fused feature, and then fuse the downsampling intermediate feature and the downsampling fused feature to generate an (i+1)^{th} downsampling feature.

The diffusion strength feature Fₜ is obtained based on feature extraction on the diffusion strength parameter t.

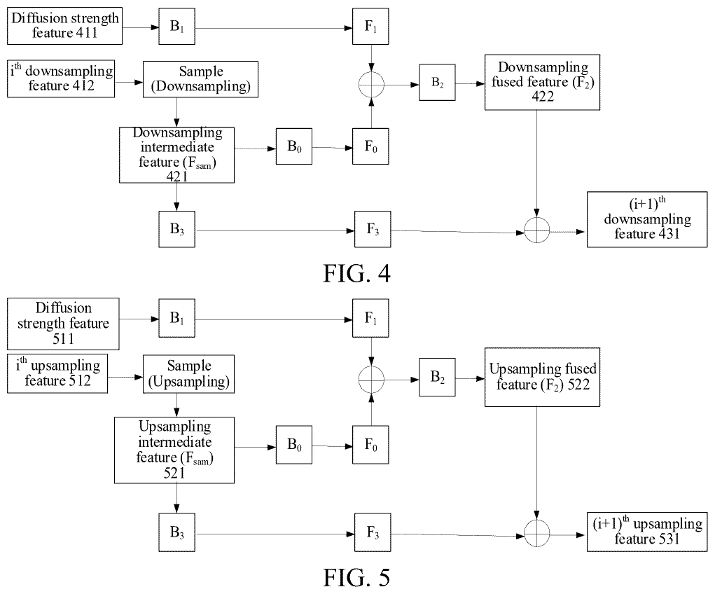

Referring to FIG. 4, FIG. 4 is a schematic internal structural diagram of a residual layer ResBlock-D according to an exemplary embodiment of this disclosure.

The process of generating the (i+1)^{th} downsampling feature will be described by taking ResBlock being ResBlock-D as an example.

The sampling layer (Sample) in the residual layer ResBlock-D is configured for performing downsampling on the i^{th} downsampling feature 412 to obtain a downsampling intermediate feature 421 (Fₛₐₘ). By representing the i^{th} downsampling feature 412 with Fᵢₙ, representing the diffusion strength feature 411 with Fₜ, representing the downsampling fused feature 422 with F₂, and representing the (i+1)^{th} downsampling feature 431 outputted by the residual layer with Fₒᵤₜ, the computation process of Fₒᵤₜ is as follows:

$${F}_{sam} = Sample ( {F}_{in} ) ;$$

$${F}_{0} = {B}_{0} ( {F}_{sam} ) = SiLU ( GN ( CNN ( {F}_{sam} ) ) ) ;$$

$${F}_{1} = {B}_{1} ( {F}_{t} ) = SiLU ( linear ( {F}_{t} ) ) ;$$

$${F}_{2} = {B}_{2} ( {F}_{0} ⊕ {F}_{1} ) = SiLU ( GN ( CNN ( {F}_{0} ⊕ {F}_{1} ) ) ) ;$$

$${F}_{3} = {B}_{3} ( {F}_{sam} ) = SiLU ( GN ( CNN ( {F}_{sam} ) ) ) ;$$

$${F}_{out} = {F}_{2} ⊕ {F}_{3} ,$$

where ⊕ is a tensor addition operation following a tensor propagation mechanism, SiLU is an activation function, linear is a linear neural network, GN is group normalization, and CNN is a two-dimensional convolutional operation.

In the upsampling process, the residual layer ResBlock-U is configured for fusing the i^{th} upsampling feature and the diffusion strength feature through skip connection.

In regard to the upsampling diffusion process of a single upsampling layer, in some embodiments, the computer device may perform upsampling on the i^{th} upsampling feature to obtain an upsampling intermediate feature, and fuse the diffusion strength feature and the upsampling intermediate feature to generate an upsampling fused feature, and then fuse the upsampling intermediate feature and the upsampling fused feature to generate an (i+1)^{th} upsampling feature.

The diffusion strength feature Fₜ is obtained based on feature extraction on the diffusion strength parameter t.

Referring to FIG. 5, FIG. 5 is a schematic internal structural diagram of a residual layer ResBlock-U according to an exemplary embodiment of this disclosure.

The process of generating the (i+1)^{th} upsampling feature will be described by taking ResBlock being ResBlock-U as an example.

The sampling layer (Sample) in the residual layer ResBlock-U is configured for performing upsampling on the i^{th} upsampling feature 512 to obtain an upsampling intermediate feature 521 (Fₛₐₘ). By representing the i^{th} upsampling feature 512 with Fᵢₙ, representing the diffusion strength feature 511 with Fₜ, representing the upsampling fused feature 522 with F₂, and representing the (i+1)^{th} upsampling feature 531 outputted by the residual layer with Fₒᵤₜ, the computation process of Fₒᵤₜ is as follows:

$${F}_{sam} = Sample ( {F}_{in} ) ;$$

$${F}_{0} = {B}_{0} ( {F}_{sam} ) = SiLU ( GN ( CNN ( {F}_{sam} ) ) ) ;$$

$${F}_{1} = {B}_{1} ( {F}_{t} ) = SiLU ( linear ( {F}_{t} ) ) ;$$

$${F}_{2} = {B}_{2} ( {F}_{0} ⊕ {F}_{1} ) = SiLU ( GN ( CNN ( {F}_{0} ⊕ {F}_{1} ) ) ) ;$$

$${F}_{3} = {B}_{3} ( {F}_{sam} ) = SiLU ( GN ( CNN ( {F}_{sam} ) ) ) ;$$

$${F}_{out} = {F}_{2} ⊕ {F}_{3} ,$$

where ⊕ is a tensor addition operation following a tensor propagation mechanism, SiLU is an activation function, linear is a linear neural network, GN is group normalization, and CNN is a two-dimensional convolutional operation.

In this embodiment, the i^{th} upsampling feature (or i^{th} downsampling feature) and the diffusion strength feature may be fused based on the residual layer ResBlock through skip connection, thus achieving the control of the reverse diffusion strength in the depth completion process by using the diffusion strength feature.

In order to obtain a dense depth map with a high depth information completeness, in some embodiments, the computer device may also achieve depth completion through multi-round iterations.

In some embodiments, in the depth completion processing through N-round iterations, the diffusion strength parameters used in each round may be different. In some embodiments, as the number of rounds of iteration increases, the diffusion strength parameter may become smaller, thus achieving a depth completion process from coarse to fine.

In some embodiments, before depth completion, the computer device may firstly determine a diffusion strength parameter sequence, where the diffusion strength parameter sequence includes N diffusion strength parameters (N is a positive integer), and a (k+1)^{th} diffusion strength parameter is smaller than a k^{th} diffusion strength parameter, where k is an integer from 1 to N−1.

In some embodiments, the diffusion strength parameter sequence may be randomly determined based on a (0,1) uniform distribution. For example, the computer device may randomly select N diffusion strength parameters based on a (0,1) uniform distribution, sort them in a descending order, denote them as {t₀, t₁, . . . , t_{N-1}}, and then sequentially use t₀ to tₙ₋₁ as diffusion strength parameters tᵢ as inputs for each iteration.

In some embodiments, the computer device may diffuse and complete the aggregated feature based on the diffusion strength parameters in the diffusion strength parameter sequence through the depth completion network via N-round iterations to obtain the depth completion feature.

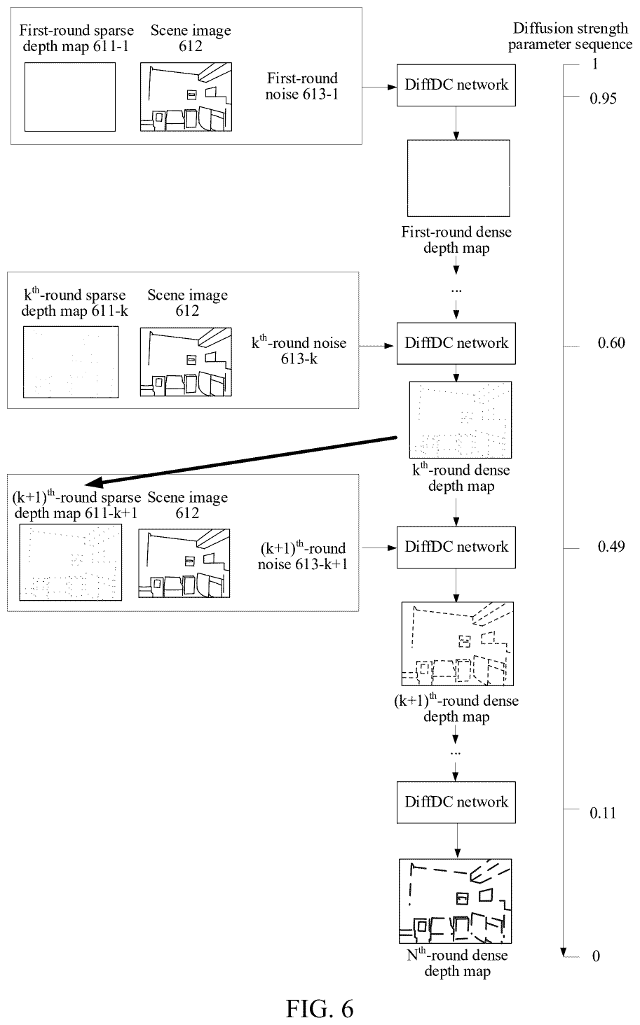

Referring to FIG. 6, FIG. 6 is a schematic diagram of a process of diffusing and completing an aggregated feature through a depth completion network via N-round iterations according to an exemplary embodiment of this disclosure.

As shown in FIG. 6, for the first-round iteration, an input of a DiffDC network is the first-round aggregated feature obtained by aggregating features of a sparse depth map 611-1 and a scene image 612 and then performing noise addition processing through the first-round noise 613-1.

Only as an example, the diffusion strength parameter adopted in the first-round iteration is 0.95.

Description will be made below by taking a k^{th}-round iteration as an example. In the k^{th}-round iteration, the computer device aggregates features of a scene image 612 and a k^{th}-round sparse depth map 611-k, and performs noise addition processing through a k^{th}-round noise 613-k to obtain a k^{th}-round aggregated feature, where the k^{th}-round noise is randomly generated based on a Gaussian distribution. For example, the value ε of each pixel in a noisy image composed of the k^{th}-round noise is randomly determined based on a Gaussian distribution with a mean value of 0 and a standard deviation of 1. That is, ε˜G(0,1).

A (k+1)^{th}-round sparse depth map is a k^{th}-round dense depth map obtained through k^{th}-round depth completion processing, that is, a k^{th}-round sparse depth map 611-k is a (k−1)^{th}-round dense depth map generated by a previous-round iteration.

In some embodiments, the computer device diffuses and completes the k^{th}-round aggregated feature based on the k^{th} diffusion strength parameter in the diffusion strength parameter sequence through the depth completion network to obtain a k^{th}-round depth completion feature, and performs image restoration based on the k^{th}-round depth completion feature to obtain a k^{th}-round dense depth map.

Only as an example, the diffusion strength parameter adopted in the k^{th}-round iteration is 0.60.

Similarly, in a (k+1)^{th}-round iteration, the computer device aggregates features of a scene image 612 and a (k+1)^{th} sparse depth map 611-k+1, performs noise addition processing through a (k+1)^{th}-round noise 613-k+1 to obtain a (k+1)^{th}-round aggregated feature, and diffuses and completes the (k+1)^{th}-round aggregated feature through the depth completion network to obtain a (k+1)^{th}-round depth completion feature, and performs image restoration based on the (k+1)^{th}-round depth completion feature to obtain a (k+1)^{th}-round dense depth map.

Only as an example, the diffusion strength parameter adopted in the (k+1)^{th}-round iteration is 0.49.

The (k+1)^{th}-round sparse depth map 611-k+1 is a k^{th}-round dense depth map generated in k^{th}-round iteration.

In some embodiments, by representing the scene image with I_{ref}, representing the first-round sparse depth map with Dₛₚₐᵣₛₑ, representing the diffusion strength parameter with tᵢ, representing the dense depth map generated based on the diffusion strength parameter tᵢ with Dₜ_{ᵢ}, representing the dense depth map generated based on the diffusion strength parameter tᵢ₋₁ with Dₜ_{_{i−1}}, and representing the DiffDC network with f, the depth completion process through multi-round iterations may be represented as the following formula:

$${D}_{{t}_{i}} = f ( {D}_{{t}_{i}} , {D}_{{t}_{i - 1}} , {I}_{ref} , {D}_{sparse} , {t}_{i} ) .$$

In some embodiments, in the depth completion process through multi-round iterations, the computer device uses Dₜ_{_{i−1}} as a prerequisite when the diffusion strength parameter is tᵢ to compute Dₜ_{ᵢ}, till an N^{th}-round depth completion process, thus obtaining an N^{th}-round dense depth map as a final dense depth map.

Only as an example, the diffusion strength parameter adopted in the N^{th}-round iteration is 0.11.

In this embodiment, N-round iterative depth completion is performed on the aggregated feature through the depth completion network. In each round of iteration, the dense depth map generated by the previous-round iteration is used as an input, and the diffusion strength parameter which sequentially decreases is adopted in each round of iteration, thus achieving the depth completion process from coarse to fine and improving the quality of depth completion.

In order to train the depth completion network, in some embodiments, the computer device may acquire a sample scene image, a sample sparse depth map, sample noise, and a sample depth map, aggregate features of the sample scene image and the sample sparse depth map, then perform noise addition processing through the sample noise to obtain a sample aggregated feature, and input the sample aggregated feature into the depth completion network to obtain a sample depth completion feature, perform image restoration based on the sample depth completion feature to obtain a sample dense depth map, and uses the sample depth map as a supervision, determine a completion loss based on a difference between the sample dense depth map and the sample depth map, and train the depth completion network based on the completion loss.

In order to improve the training quality, in some embodiments, the computer device may also introduce a sample guidance map in the training process to reduce the diffusion randomness of the depth completion network.

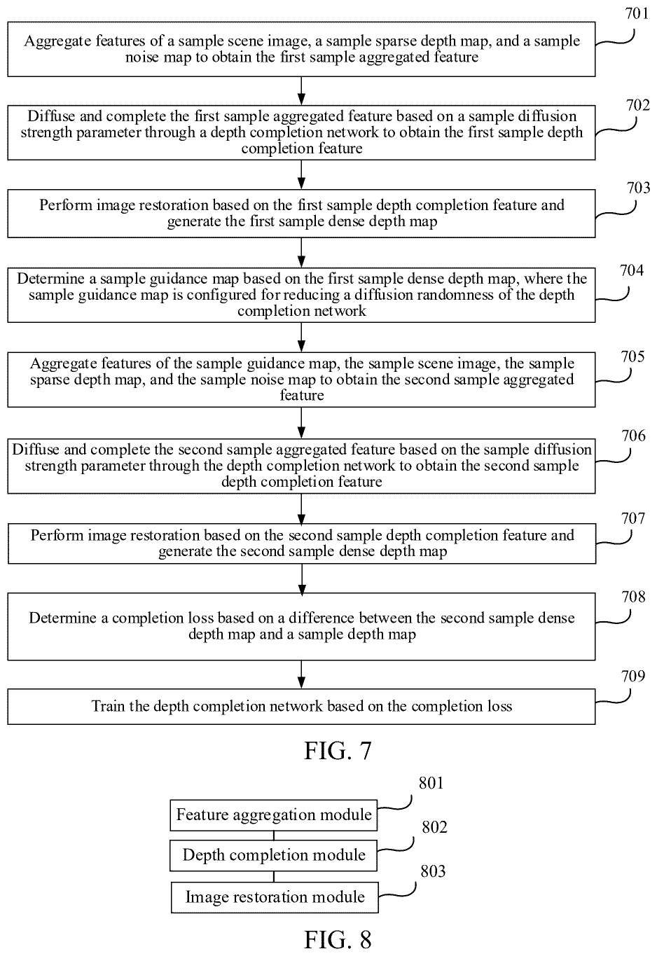

Referring to FIG. 7, FIG. 7 is a flowchart of training a depth completion network according to an exemplary embodiment of this disclosure. The process includes the following operations:

Operation 701: Aggregate features of a sample scene image, a sample sparse depth map, and a sample noise map to obtain the first sample aggregated feature.

In regard with the mode of generating the sample noise map, in a possible implementation, the computer device may perform noise addition on the sample depth map by using Gaussian noise based on the sample diffusion strength parameter to obtain the sample noise map.

Exemplarily, by representing the sample noise map with Dₜ, representing the sample diffusion strength parameter with t, and representing the sample depth map with D_{com}, Dₜ may be represented as the following formula:

$${D}_{t} = \sqrt{β ( t )} {D}_{com} + \sqrt{1 - β ( t )} ε ,$$

where β(t)=e^{-10t}^{²}⁻¹⁰^{^{−4}}, and the value ε of the random noise added to each pixel point is determined based on a Gaussian distribution with a mean value of 0 and a standard deviation of 1. That is, ε˜G(0,1).

In some embodiments, the first sample aggregated feature F_{raw}1 may be represented as the following formula:

$${F}_{raw} 1 = Concatenate ( {D}_{t} , {F}_{r} , {F}_{s} ) ,$$

where Dₜ represents the sample noise map, Fᵣ represents the sample scene feature encoded based on the sample scene image, and Fₛ represents the sample sparse depth feature encoded based on the sample sparse depth map.

Operation 702: Diffuse and complete the first sample aggregated feature based on a sample diffusion strength parameter through a depth completion network to obtain the first sample depth completion feature.

Operation 703: Perform image restoration based on the first sample depth completion feature and generate the first sample dense depth map.

Exemplarily, by representing the sample noise map with Dₜ, representing the sample diffusion strength parameter with t, representing the sample scene image with I_{ref}, representing the sample sparse depth map with Dₛₚₐᵣₛₑ, and representing the DiffDC network with f, the first sample dense depth map may be represented as the following formula:

$$f ( {D}_{t} , 0 , {I}_{ref} , {D}_{sparse} , t ) .$$

Operation 704: Determine a sample guidance map based on the first sample dense depth map, where the sample guidance map is configured for reducing a diffusion randomness of the depth completion network.

In regard to the mode of determining the sample guidance map, in a possible implementation, a probability that the sample guidance map is assigned to the first sample dense depth map is the first probability, and a probability that the sample guidance map is assigned to a tensor with element values being zero is the second probability, and a sum of the first probability and the second probability is 1.

Exemplarily, the first probability and the second probability are both 50%. By representing the sample guidance map with [symbol] , in the training process, [symbol] is assigned to f(Dₜ, 0, I_{ref}, Dₛₚₐᵣₛₑ, t) according to a probability of 50%, and is assigned to a tensor with the same shape as D_{com} but element values being all 0 according to a possibility of other 50%.

Operation 705: Aggregate features of the sample guidance map, the sample scene image, the sample sparse depth map, and the sample noise map to obtain the second sample aggregated feature.

In some embodiments, the second sample aggregated feature F_{raw}2 may be represented as the following formula:

$${F}_{raw} 2 = Concatenate ( {D}_{t} , {F}_{r} , {F}_{s} , ) ,$$

where Dₜ represents the sample noise map, Fᵣ represents the sample scene feature encoded based on the sample scene image, Fₛ represents the sample sparse depth feature encoded based on the sample sparse depth map, and [symbol] represents the sample guidance map.

Operation 706: Diffuse and complete the second sample aggregated feature based on the sample diffusion strength parameter through the depth completion network to obtain the second sample depth completion feature.

Operation 707: Perform image restoration based on the second sample depth completion feature and generate the second sample dense depth map.

In some embodiments, the second sample dense depth map may be represented as the following formula:

$$f ( {D}_{t} , , {I}_{ref} , {D}_{sparse} , t ) .$$

Operation 708: Determine a completion loss based on a difference between the second sample dense depth map and a sample depth map.

Exemplarily, by representing the completion loss with L_{D}_{_{com}}, the completion loss may be computed through the following formula:

$${L}_{{D}_{com}} = {E}_{ε ∼ G ( 0 , I ) , t ∼ U ( 0 , I )} {‖ f ( {D}_{t} , , {I}_{ref} , {D}_{sparse} , t ) - {D}_{com} ‖}^{2} ;$$

$${D}_{t} = \sqrt{β ( t )} {D}_{com} + \sqrt{1 - β ( t )} ε ,$$

where G is a Gaussian distribution, U is a uniform distribution, β(t)=e^{-10t}^{²}⁻¹⁰^{^{−4}}, and f is a DiffDC network.

Operation 709: Train the depth completion network based on the completion loss.

Only as an example, the computer device may train the depth completion network through a gradient descent method or any other training mode.

In this embodiment, by determining the second sample dense depth map based on the sample guidance map, it can be configured for guiding the diffusion process of the depth completion network and reduce the diffusion randomness of the depth completion network, that is, a previous computation result is used as a reference in a current diffusion process, so that the current calculation process does not deviate too much from the previous calculation result, thus achieving a better training effect.

In some embodiments, the depth map completion method provided in this embodiment of this disclosure may be applied to various scenarios, such as three-dimensional modeling scenario, autonomous driving scenario, 3D printing scenario, and so on.

For the three-dimensional modeling scenario:

In some embodiment, in the three-dimensional modeling scenario, only a sparse depth map corresponding to a three-dimensional scene can be acquired through a depth camera. Therefore, in order to improve the efficiency and accuracy of three-dimensional modeling, the computer device may firstly generate a dense depth map based on the sparse depth map, and then use the dense depth map in a three-dimensional modeling process.

In some embodiments, the computer device firstly acquires a scene image corresponding to the three-dimensional modeling scenario obtained by a camera device through photographing, as well as a sparse depth map acquired by a depth camera, then performs feature aggregation on the scene image and the sparse depth map, performs noise addition processing through a noise to obtain an aggregated feature, diffuses and completes the aggregated feature based on a diffusion strength parameter through a depth completion network to obtain a depth completion feature, and performs image restoration based on the depth completion feature to obtain a dense depth map.

In some embodiments, in order to improve the depth completion accuracy, the computer device may determine a diffusion strength parameter sequence, the diffusion strength parameter sequence includes N diffusion strength parameters, a (k+1)^{th} diffusion strength parameter is smaller than a k^{th} diffusion strength parameter, and then the aggregated feature is diffused and completed based on the diffusion strength parameters in the diffusion strength parameter sequence through the depth completion network via N-round iterations to obtain a depth completion feature.

For the generation process of a k^{th}-round dense depth map, in a possible implementation, the computer device aggregates features of the scene image and a k^{th}-round sparse depth map to obtain a k^{th}-round aggregated feature, where a (k+1)^{th}-round sparse depth map is a k^{th}-round dense depth map obtained through k^{th}-round depth completion processing, the k^{th}-round aggregated feature undergoes noise addition processing through k^{th}-round noise, and the k^{th}-round noise is randomly generated based on a Gaussian distribution. Further, the computer device diffuses and completes the k^{th}-round aggregated feature based on the k^{th} diffusion strength parameter in the diffusion strength parameter sequence through the depth completion network to obtain a k^{th}-round depth completion feature, and performs image restoration based on the k^{th}-round depth completion feature to obtain a k^{th}-round dense depth map.

In some embodiments, in order to fully learn the image feature and improve the depth completion efficiency, the depth completion network may include a downsampling diffusion subnetwork and an upsampling diffusion subnetwork. In a possible implementation, the computer device firstly performs downsampling diffusion on the aggregated feature based on the diffusion strength parameter through the downsampling diffusion subnetwork to obtain a downsampling depth feature, and then performs upsampling diffusion on the downsampling depth feature based on the diffusion strength parameter through the upsampling diffusion subnetwork to obtain a depth completion feature.

In some embodiments, in order to improve the sampling accuracy, the downsampling diffusion subnetwork may include n downsampling layers, and the upsampling diffusion subnetwork may include n upsampling layers. In a possible implementation, the computer device performs downsampling diffusion on the aggregated feature based on the diffusion strength parameter through the first downsampling layer to obtain the first downsampling feature, then performs downsampling diffusion on an i^{th} downsampling feature based on the diffusion strength parameter through an (i+1)^{th} downsampling layer to obtain an (i+1)^{th} downsampling feature, and then uses an n^{th} downsampling feature outputted by an n^{th} downsampling layer as the downsampling depth feature. Further, the computer device performs upsampling diffusion on the downsampling depth feature based on the diffusion strength parameter through the first upsampling layer to obtain the first upsampling feature, then performs upsampling diffusion on an i^{th} upsampling feature based on the diffusion strength parameter through an (i+1)^{th} upsampling layer to obtain an (i+1)^{th} upsampling feature, and finally uses an n^{th} upsampling feature outputted by an n^{th} upsampling layer as the depth completion feature.

In some embodiments, in regard to the downsampling diffusion process of a single downsampling layer, in a possible implementation, the computer device performs downsampling on the i^{th} downsampling feature to obtain a downsampling intermediate feature, fuses the diffusion strength feature and the downsampling intermediate feature to generate a downsampling fused feature, where the diffusion strength feature is obtained based on feature extraction on the diffusion strength parameter, and then fuses the downsampling intermediate feature and the downsampling fused feature to generate an (i+1)^{th} downsampling feature.

In some embodiments, in regard to the upsampling diffusion process of a single upsampling layer, in a possible implementation, the computer device performs upsampling on the i^{th} upsampling feature to obtain an upsampling intermediate feature, fuses the diffusion strength feature and the upsampling intermediate feature to generate an upsampling fused feature, where the diffusion strength feature is obtained based on feature extraction on the diffusion strength parameter, and then fuses the upsampling intermediate feature and the upsampling fused feature to generate an (i+1)^{th} upsampling feature.

In a possible implementation, the computer device may also fuse the i^{th} upsampling feature and an (n−i)^{th} downsampling feature to obtain an i^{th} fused feature, and then perform upsampling diffusion on the i^{th} fused feature based on the diffusion strength parameter through the (i+1)^{th} upsampling layer to obtain an (i+1)^{th} upsampling feature.

In some embodiments, in regard to the process of obtaining the aggregated feature, in a possible implementation, the computer device firstly encodes the feature of the sparse depth map through the first encoder to obtain a sparse depth feature, and encodes the feature of the scene image through the second encoder to obtain a scene feature, aggregates the scene feature and the sparse depth feature, and performs noise addition processing through a noise to obtain an aggregated feature, where dimensions of the scene feature, the sparse depth feature, and the noise are consistent.

For the autonomous driving scenario:

In some embodiment, in the autonomous driving scenario, only a sparse depth map corresponding to a driving scene can be acquired through devices such as a laser radar. Therefore, in order to improve the efficiency and accuracy of autonomous driving, the computer device may firstly generate a dense depth map based on the sparse depth map, and then use the dense depth map in an autonomous driving process.

In some embodiments, the computer device firstly acquires a driving round condition image obtained by a camera device through photographing, as well as a sparse depth map corresponding to the driving road condition image, then performs feature aggregation on the driving road condition image and the sparse depth map, performs noise addition processing through a noise to obtain an aggregated feature, diffuses and completes the aggregated feature based on a diffusion strength parameter through a depth completion network to obtain a depth completion feature, and performs image restoration based on the depth completion feature to obtain a dense depth map.

In some embodiments, in order to improve the depth completion accuracy, the computer device may determine a diffusion strength parameter sequence, the diffusion strength parameter sequence includes N diffusion strength parameters, a (k+1)^{th} diffusion strength parameter is smaller than a k^{th} diffusion strength parameter, and then the aggregated feature is diffused and completed based on the diffusion strength parameters in the diffusion strength parameter sequence through the depth completion network via N-round iterations to obtain a depth completion feature.

For the generation process of a k^{th}-round dense depth map, in a possible implementation, the computer device aggregates features of the driving road condition image and a k^{th}-round sparse depth map to obtain a k^{th}-round aggregated feature, where a (k+1)^{th}-round sparse depth map is a k^{th}-round dense depth map obtained through k^{th}-round depth completion processing, the k^{th}-round aggregated feature undergoes noise addition processing through k^{th}-round noise, and the k^{th}-round noise is randomly generated based on a Gaussian distribution. Further, the computer device diffuses and completes the k^{th}-round aggregated feature based on the k^{th} diffusion strength parameter in the diffusion strength parameter sequence through the depth completion network to obtain a k^{th}-round depth completion feature, and performs image restoration based on the k^{th}-round depth completion feature to obtain a k^{th}-round dense depth map.

In some embodiments, in order to fully learn the image feature and improve the depth completion efficiency, the depth completion network may include a downsampling diffusion subnetwork and an upsampling diffusion subnetwork. In a possible implementation, the computer device firstly performs downsampling diffusion on the aggregated feature based on the diffusion strength parameter through the downsampling diffusion subnetwork to obtain a downsampling depth feature, and then performs upsampling diffusion on the downsampling depth feature based on the diffusion strength parameter through the upsampling diffusion subnetwork to obtain a depth completion feature.

In some embodiments, in order to improve the sampling accuracy, the downsampling diffusion subnetwork may include n downsampling layers, and the upsampling diffusion subnetwork may include n upsampling layers. In a possible implementation, the computer device performs downsampling diffusion on the aggregated feature based on the diffusion strength parameter through the first downsampling layer to obtain the first downsampling feature, then performs downsampling diffusion on an i^{th} downsampling feature based on the diffusion strength parameter through an (i+1)^{th} downsampling layer to obtain an (i+1)^{th} downsampling feature, and then uses an n^{th} downsampling feature outputted by an n^{th} downsampling layer as the downsampling depth feature. Further, the computer device performs upsampling diffusion on the downsampling depth feature based on the diffusion strength parameter through the first upsampling layer to obtain the first upsampling feature, then performs upsampling diffusion on an i^{th} upsampling feature based on the diffusion strength parameter through an (i+1)^{th} upsampling layer to obtain an (i+1)^{th} upsampling feature, and finally uses an n^{th} upsampling feature outputted by an n^{th} upsampling layer as the depth completion feature.

In some embodiments, in regard to the downsampling diffusion process of a single downsampling layer, in a possible implementation, the computer device performs downsampling on the i^{th} downsampling feature to obtain a downsampling intermediate feature, fuses the diffusion strength feature and the downsampling intermediate feature to generate a downsampling fused feature, where the diffusion strength feature is obtained based on feature extraction on the diffusion strength parameter, and then fuses the downsampling intermediate feature and the downsampling fused feature to generate an (i+1)^{th} downsampling feature.

In some embodiments, in regard to the upsampling diffusion process of a single upsampling layer, in a possible implementation, the computer device performs upsampling on the i^{th} upsampling feature to obtain an upsampling intermediate feature, fuses the diffusion strength feature and the upsampling intermediate feature to generate an upsampling fused feature, where the diffusion strength feature is obtained based on feature extraction on the diffusion strength parameter, and then fuses the upsampling intermediate feature and the upsampling fused feature to generate an (i+1)^{th} upsampling feature.

In a possible implementation, the computer device may also fuse the i^{th} upsampling feature and an (n−i)^{th} downsampling feature to obtain an i^{th} fused feature, and then perform upsampling diffusion on the i^{th} fused feature based on the diffusion strength parameter through the (i+1)^{th} upsampling layer to obtain an (i+1)^{th} upsampling feature.

In some embodiments, in regard to the process of obtaining the aggregated feature, in a possible implementation, the computer device firstly encodes the feature of the sparse depth map through the first encoder to obtain a sparse depth feature, and encodes the feature of the driving road condition image through the second encoder to obtain a driving scene feature, aggregates the driving scene feature and the sparse depth feature, and performs noise addition processing through a noise to obtain an aggregated feature, where dimensions of the driving scene feature, the sparse depth feature, and the noise are consistent.

Referring to FIG. 8, FIG. 8 is a structural block diagram of a depth map completion apparatus according to an exemplary embodiment of this disclosure. The apparatus includes:

a feature aggregation module 801, configured to aggregate features of a scene image and a sparse depth map to obtain an aggregated feature, where the sparse depth map is a depth map with missing depth information corresponding to the scene image, and the aggregated feature undergoes noise addition processing through a noise;

a depth completion module 802, configured to diffuse and complete the aggregated feature based on a diffusion strength parameter through a depth completion network to obtain a depth completion feature, where the depth completion network is based on a diffusion model, and the diffusion strength parameter is configured for controlling a reverse diffusion strength in a depth completion process; and

an image restoration module 803, configured to perform image restoration based on the depth completion feature to obtain a dense depth map, where a depth information completeness of the dense depth map is higher than a depth information completeness of the sparse depth map.

In some embodiments, the apparatus further includes an iteration module configured to:

determine a diffusion strength parameter sequence, where the diffusion strength parameter sequence includes N diffusion strength parameters, and a (k+1)^{th} diffusion strength parameter is smaller than a k^{th} diffusion strength parameter, where N is a positive integer and k is a positive integer.

In some embodiments, the depth completion module 802 is configured to:

diffuse and complete the aggregated feature based on the diffusion strength parameter in the diffusion strength parameter sequence through the depth completion network via N-round iterations to obtain the depth completion feature.

In some embodiments, the feature aggregation module 801 is configured to:

aggregate features of the scene image and a k^{th}-round sparse depth map to obtain a k^{th}-round aggregated feature, where a (k+1)^{th}-round sparse depth map is a k^{th}-round dense depth map obtained through k^{th}-round depth completion processing, the k^{th}-round aggregated feature undergoes noise addition processing through k^{th}-round noise, and the k^{th}-round noise is randomly generated based on a Gaussian distribution.

In some embodiments, the depth completion module 802 is configured to:

diffuse and complete the k^{th}-round aggregated feature based on the k^{th} diffusion strength parameter in the diffusion strength parameter sequence through the depth completion network to obtain a k^{th}-round depth completion feature.

In some embodiments, the image restoration module 803 is configured to:

perform image restoration based on the k^{th}-round depth completion feature to obtain the k^{th}-round dense depth map.

In some embodiments, the depth completion network includes a downsampling diffusion subnetwork and an upsampling diffusion subnetwork, and the depth completion module 802 is configured to:

perform downsampling diffusion on the aggregated feature based on the diffusion strength parameter through the downsampling diffusion subnetwork to obtain a downsampling depth feature; and

perform upsampling diffusion on the downsampling depth feature based on the diffusion strength parameter through the upsampling diffusion subnetwork to obtain the depth completion feature.

In some embodiments, the downsampling diffusion subnetwork includes n downsampling layers, and the upsampling diffusion subnetwork includes n upsampling layers, where n is a positive integer; the depth completion module 802 is configured to:

perform downsampling diffusion on the aggregated feature based on the diffusion strength parameter through the first downsampling layer to obtain the first downsampling feature;

perform downsampling diffusion on an i^{th} downsampling feature based on the diffusion strength parameter through an (i+1)^{th} downsampling layer to obtain an (i+1)^{th} downsampling feature, where i is a positive integer; and

use an n^{th} downsampling feature outputted by an n^{th} downsampling layer as the downsampling depth feature;

perform upsampling diffusion on the downsampling depth feature based on the diffusion strength parameter through the first upsampling layer to obtain the first upsampling feature;

perform upsampling diffusion on an i^{th} upsampling feature based on the diffusion strength parameter through an (i+1)^{th} upsampling layer to obtain an (i+1)^{th} upsampling feature; and

use an n^{th} upsampling feature outputted by an n^{th} upsampling layer as the depth completion feature.

In some embodiments, the depth completion module 802 is configured to:

perform downsampling on the i^{th} downsampling feature to obtain a downsampling intermediate feature;

fuse the diffusion strength feature and the downsampling intermediate feature to generate a downsampling fused feature, where the diffusion strength feature is obtained based on feature extraction on the diffusion strength parameter; and

fuse the downsampling intermediate feature and the downsampling fused feature to generate the (i+1)^{th} downsampling feature.

In some embodiments, the depth completion module 802 is configured to:

perform upsampling on the i^{th} upsampling feature to obtain an upsampling intermediate feature;

fuse the diffusion strength feature and the upsampling intermediate feature to generate an upsampling fused feature, where the diffusion strength feature is obtained based on feature extraction on the diffusion strength parameter; and

fuse the upsampling intermediate feature and the upsampling fused feature to generate the (i+1)^{th} upsampling feature.

In some embodiments, the depth completion module 802 is configured to:

fuse the i^{th} upsampling feature and an (n−i)^{th} downsampling feature to obtain an i^{th} fused feature; and

perform upsampling diffusion on the i^{th} fused feature based on the diffusion strength parameter through the (i+1)^{th} upsampling layer to obtain the (i+1)^{th} upsampling feature.

In some embodiments, the feature aggregation module 801 is configured to:

encode the feature of the sparse depth map through the first encoder to obtain a sparse depth feature;

encode the feature of the scene image through the second encoder to obtain a scene feature; and

aggregate the scene feature and the sparse depth feature, and perform the noise addition processing through the noise to obtain the aggregated feature, where dimensions of the scene feature, the sparse depth feature, and the noise are consistent.

In some embodiments, the apparatus further includes a training module configured to:

aggregate features of a sample scene image, a sample sparse depth map, and a sample noise map to obtain the first sample aggregated feature;

diffuse and complete the first sample aggregated feature based on a sample diffusion strength parameter through the depth completion network to obtain the first sample depth completion feature;

perform image restoration based on the first sample depth completion feature and generate the first sample dense depth map;

determine a sample guidance map based on the first sample dense depth map, where the sample guidance map is configured for reducing a diffusion randomness of the depth completion network;

aggregate features of the sample guidance map, the sample scene image, the sample sparse depth map, and the sample noise map to obtain the second sample aggregated feature;

diffuse and complete the second sample aggregated feature based on the sample diffusion strength parameter through the depth completion network to obtain the second sample depth completion feature;

perform image restoration based on the second sample depth completion feature and generate the second sample dense depth map;

determine a completion loss based on a difference between the second sample dense depth map and a sample depth map; and

train the depth completion network based on the completion loss.

In some embodiments, a probability that the sample guidance map is assigned to the first sample dense depth map is the first probability, and a probability that the sample guidance map is assigned to a tensor with element values being zero is the second probability, and a sum of the first probability and the second probability is 1.

In some embodiments, the training module is configured to:

perform noise addition to the sample depth map by using Gaussian noise based on the diffusion strength parameter to obtain the sample noise map.

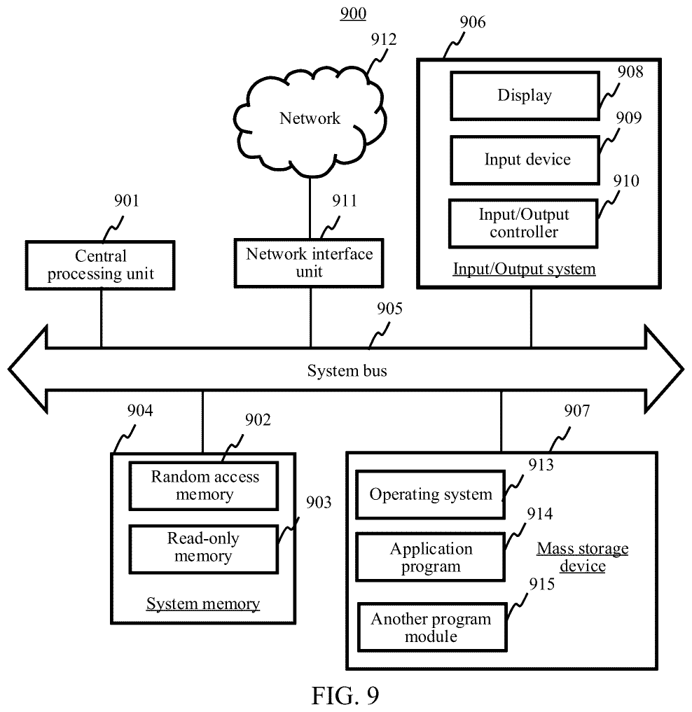

Refer to FIG. 9, FIG. 9 is a schematic diagram of a structure of a computer device according to an exemplary embodiment of this disclosure.

Specifically, the computer device 900 includes a central processing unit (CPU) 901, a system memory 904 including a random access memory 902 and a read-only memory 903, and a system bus 905 connecting the system memory 904 and the central processing unit 901. The server 900 further includes a basic input/output (I/O) system 906 assisting in information transmission between components in the computer, and a mass storage device 907 configured to store an operating system 913, an application program 914, and another program module 915.

The basic I/O system 906 includes a display 908 configured to display information and an input device 909 such as a mouse or a keyboard that is configured to input information by a user. The display 908 and the input device 909 are both connected to the CPU 901 through an input/output controller 910 connected to the system bus 905. The basic I/O system 906 may further include the input/output controller 910 configured to receive and process inputs from multiple other devices such as a keyboard, a mouse, and an electronic stylus. Similarly, the input/output controller 910 further provides an output to a display screen, a printer, or another type of output device.

The mass storage device 907 is connected to the CPU 901 through a mass storage controller (not shown) connected to the system bus 905. The mass storage device 907 and a computer-readable medium associated therewith provide non-volatile storage for the computer device 900. That is, the mass storage device 907 may include the computer-readable medium (not shown) such as a hard disc or a drive.

Without losing generality, the computer-readable medium may include a computer storage medium and a communication medium. The computer storage medium includes volatile, non-volatile media, removable and non-removable media implemented by using any method or technology configured for storing information such as computer-readable instructions, data structures, program modules, or other data. The computer storage medium includes a random access memory (RAM), a read only memory (ROM), a flash memory or another solid-state storage technology, a compact disc read-only memory (CD-ROM), a digital versatile disc (DVD) or another optical memory, a magnetic cassette, a magnetic tape, a magnetic disc memory, or another magnetic storage device. Certainly, those skilled in the art may learn that the computer storage medium is not limited to the foregoing several types. The system memory 904 and the mass storage device 907 may be collectively referred to as a memory.

The memory stores one or more programs, the one or more programs are configured to be executed by one or more CPUs 901, the one or more programs include instructions configured for implementing the foregoing methods, and the CPU 901 executes the one or more programs to implement the method provided in each method embodiment described above.

According to the embodiments of this disclosure, the computer device 900 may further be connected, through a network such as the Internet, to a remote computer on the network to run. That is, the computer device 900 may be connected to a network 912 by using a network interface unit 911 connected to the system bus 905, or may be connected to another type of network or a remote computer system (not shown) by using a network interface unit 911.

The memory further includes one or more programs, the one or more programs is stored in the memory, and the one or more programs includes operations performed by the computer device in the method according to the embodiment of this disclosure.

An embodiment of this disclosure further provides a computer-readable storage medium, having at least one instruction stored therein. The at least one instruction is loaded and executed by a processor to implement the method described in any of the above embodiments.

In some embodiments, the computer-readable storage medium may include an ROM, an RAM, a solid state drive (SSD), an optical disc, or the like. The RAM may include a resistance random access memory (ReRAM) and a dynamic random access memory (DRAM).

An embodiment of this disclosure provides a computer program product. The computer program product includes computer instructions. The computer instructions are stored in a computer-readable storage medium. The processor of the computer device reads the computer instructions from the computer-readable storage medium, and the processor executes the computer instructions, so that the computer device performs the method in the foregoing embodiment.

Those skilled in the art may understand that all or some of the operations of the embodiments may be implemented by hardware, or may be implemented by a program instructing relevant hardware. The program may be stored in a computer-readable storage medium. The storage medium may be a read-only memory, a magnetic disc, an optical disc, or the like.

The above descriptions are merely exemplary embodiments of this disclosure, and are not intended to limit this disclosure. Any modification, equivalent replacement, or improvement made within the spirit and principle of this disclosure still fall within the scope of protection of this disclosure.

What is claimed is:

1. A depth map completion method performed by a computer device, the method comprising:
aggregating features of a scene image and a sparse depth map to obtain an aggregated feature, the sparse depth map being a depth map with missing depth information corresponding to the scene image, and the aggregated feature undergoing noise addition processing through a noise;
diffusing and completing the aggregated feature based on a diffusion strength parameter through a depth completion network to obtain a depth completion feature, the depth completion network being based on a diffusion model, and the diffusion strength parameter being configured for controlling a reverse diffusion strength in a depth completion process; and
performing image restoration based on the depth completion feature to obtain a dense depth map, a depth information completeness of the dense depth map being higher than a depth information completeness of the sparse depth map.

2. The method according to claim 1, further comprising:
determining a diffusion strength parameter sequence, the diffusion strength parameter sequence comprising N diffusion strength parameters, and a (k+1)^{th} diffusion strength parameter being smaller than a k^{th} diffusion strength parameter, N being a positive integer and k being a positive integer,
wherein diffusing and completing the aggregated feature comprises:
diffusing and completing the aggregated feature based on the diffusion strength parameter in the diffusion strength parameter sequence through the depth completion network via N-round iterations to obtain the depth completion feature.

3. The method according to claim 2,
wherein aggregating the features of the scene image and the sparse depth map to obtain the aggregated feature comprises:
aggregating the features of the scene image and a k^{th}-round sparse depth map to obtain a k^{th}-round aggregated feature, a (k+1)^{th}-round sparse depth map being a k^{th}-round dense depth map obtained through k^{th}-round depth completion processing, the k^{th}-round aggregated feature undergoing noise addition processing through a k^{th}-round noise, and the k^{th}-round noise being randomly generated based on a Gaussian distribution;
wherein diffusing and completing the aggregated feature based on the diffusion strength parameter in the diffusion strength parameter sequence through the depth completion network via the N-round iterations to obtain the depth completion feature comprises:
diffusing and completing the k^{th}-round aggregated feature based on the k^{th} diffusion strength parameter in the diffusion strength parameter sequence through the depth completion network to obtain a k^{th}-round depth completion feature; and
wherein performing image restoration based on the depth completion feature to obtain the dense depth map comprises:
performing image restoration based on the k^{th}-round depth completion feature to obtain the k^{th}-round dense depth map.

4. The method according to claim 1,
wherein the depth completion network comprises a downsampling diffusion subnetwork and an upsampling diffusion subnetwork, and
wherein diffusing and completing the aggregated feature based on the diffusion strength parameter through the depth completion network to obtain the depth completion feature comprises:
performing downsampling diffusion on the aggregated feature based on the diffusion strength parameter through the downsampling diffusion subnetwork to obtain a downsampling depth feature; and
performing upsampling diffusion on the downsampling depth feature based on the diffusion strength parameter through the upsampling diffusion subnetwork to obtain the depth completion feature.

5. The method according to claim 4,
wherein the downsampling diffusion subnetwork comprises n downsampling layers, and the upsampling diffusion subnetwork comprises n upsampling layers, n being a positive integer,
wherein performing downsampling diffusion on the aggregated feature based on the diffusion strength parameter through the downsampling diffusion subnetwork to obtain the downsampling depth feature comprises:
performing downsampling diffusion on the aggregated feature based on the diffusion strength parameter through a first downsampling layer to obtain a first downsampling feature;
performing downsampling diffusion on an i^{th} downsampling feature based on the diffusion strength parameter through an (i+1)^{th} downsampling layer to obtain an (i+1)^{th} downsampling feature, i being a positive integer; and
using an n^{th} downsampling feature outputted by an n^{th} downsampling layer as the downsampling depth feature; and
performing upsampling diffusion on the downsampling depth feature based on the diffusion strength parameter through the upsampling diffusion subnetwork to obtain the depth completion feature comprises:
performing upsampling diffusion on the downsampling depth feature based on the diffusion strength parameter through a first upsampling layer to obtain a first upsampling feature;
performing upsampling diffusion on an i^{th} upsampling feature based on the diffusion strength parameter through an (i+1)^{th} upsampling layer to obtain an (i+1)^{th} upsampling feature; and
using an n^{th} upsampling feature outputted by an n^{th} upsampling layer as the depth completion feature.

6. The method according to claim 5,
wherein performing downsampling diffusion on the i^{th} downsampling feature based on the diffusion strength parameter through the (i+1)^{th} downsampling layer to obtain the (i+1)^{th} downsampling feature comprises:
performing downsampling on the i^{th} downsampling feature to obtain a downsampling intermediate feature;
fusing a diffusion strength feature and the downsampling intermediate feature to generate a downsampling fused feature, the diffusion strength feature being obtained based on feature extraction on the diffusion strength parameter; and
fusing the downsampling intermediate feature and the downsampling fused feature to generate the (i+1)^{th} downsampling feature.

7. The method according to claim 5,
wherein performing upsampling diffusion on the i^{th} upsampling feature based on the diffusion strength parameter through the (i+1)^{th} upsampling layer to obtain the (i+1)^{th} upsampling feature comprises:
performing upsampling on the i^{th} upsampling feature to obtain an upsampling intermediate feature;
fusing a diffusion strength feature and the upsampling intermediate feature to generate an upsampling fused feature, the diffusion strength feature being obtained based on feature extraction on the diffusion strength parameter; and
fusing the upsampling intermediate feature and the upsampling fused feature to generate the (i+1)^{th} upsampling feature.

8. The method according to claim 5,
wherein performing upsampling diffusion on the i^{th} upsampling feature based on the diffusion strength parameter through the (i+1)^{th} upsampling layer to obtain the (i+1)^{th} upsampling feature comprises:
fusing the i^{th} upsampling feature and an (n−i)^{th} downsampling feature to obtain an i^{th} fused feature; and
performing upsampling diffusion on the i^{th} fused feature based on the diffusion strength parameter through the (i+1)^{th} upsampling layer to obtain the (i+1)^{th} upsampling feature.

9. The method according to claim 1,
wherein aggregating the features of the scene image and the sparse depth map to obtain the aggregated feature comprises:
encoding a feature of the sparse depth map through a first encoder to obtain a sparse depth feature;
encoding a feature of the scene image through a second encoder to obtain a scene feature; and
aggregating the scene feature and the sparse depth features, and performing noise addition processing through the noise to obtain the aggregated feature, dimensions of the scene feature, the sparse depth feature, and the noise being consistent.

10. The method according to claim 1, further comprising:
aggregating features of a sample scene image, a sample sparse depth map, and a sample noise map to obtain a first sample aggregated feature;
diffusing and completing the first sample aggregated feature based on a sample diffusion strength parameter through the depth completion network to obtain a first sample depth completion feature;
performing image restoration based on the first sample depth completion feature and generating a first sample dense depth map;
determining a sample guidance map based on the first sample dense depth map, the sample guidance map being configured for reducing a diffusion randomness of the depth completion network;
aggregating features of the sample guidance map, the sample scene image, the sample sparse depth map, and the sample noise map to obtain a second sample aggregated feature;
diffusing and completing the second sample aggregated feature based on the sample diffusion strength parameter through the depth completion network to obtain a second sample depth completion feature;
performing image restoration based on the second sample depth completion feature and generating a second sample dense depth map;
determining a completion loss based on a difference between the second sample dense depth map and a sample depth map; and
training the depth completion network based on the completion loss.

11. The method according to claim 10, wherein a probability that the sample guidance map is assigned to the first sample dense depth map is a first probability, and a probability that the sample guidance map is assigned to a tensor with element values being zero is a second probability, and a sum of the first probability and the second probability is 1.

12. The method according to claim 10, further comprising:
performing noise addition to the sample depth map by using Gaussian noise based on the diffusion strength parameter to obtain the sample noise map.

13. A depth map completion apparatus comprising:
a memory configured to store computer-readable instructions; and
a processor configured to execute the computer-readable instructions to:
aggregate features of a scene image and a sparse depth map to obtain an aggregated feature, the sparse depth map being a depth map with missing depth information corresponding to the scene image, and the aggregated feature undergoing noise addition processing through a noise;
diffuse and complete the aggregated feature based on a diffusion strength parameter through a depth completion network to obtain a depth completion feature, the depth completion network being based on a diffusion model, and the diffusion strength parameter being configured for controlling a reverse diffusion strength in a depth completion process; and
perform image restoration based on the depth completion feature to obtain a dense depth map, a depth information completeness of the dense depth map being higher than a depth information completeness of the sparse depth map.

14. The apparatus according to claim 13, wherein the processor is further configured to execute the computer-readable instructions to:
determine a diffusion strength parameter sequence, the diffusion strength parameter sequence comprising N diffusion strength parameters, and a (k+1)^{th} diffusion strength parameter being smaller than a k^{th} diffusion strength parameter, N being a positive integer and k being a positive integer; and
diffuse and complete the aggregated feature based on the diffusion strength parameter by:
diffusing and completing the aggregated feature based on the diffusion strength parameter in the diffusion strength parameter sequence through the depth completion network via N-round iterations to obtain the depth completion feature.

15. The apparatus according to claim 14,
wherein the processor is further configured to execute the computer-readable instructions to aggregate the features of the scene image and the sparse depth map to obtain the aggregated feature by:
aggregating the features of the scene image and a k^{th}-round sparse depth map to obtain a k^{th}-round aggregated feature, a (k+1)^{th}-round sparse depth map being a k^{th}-round dense depth map obtained through k^{th}-round depth completion processing, the k^{th}-round aggregated feature undergoing noise addition processing through a k^{th}-round noise, and the k^{th}-round noise being randomly generated based on a Gaussian distribution;
wherein the processor is further configured to execute the computer-readable instructions to diffuse and complete the aggregated feature by:
diffusing and completing the k^{th}-round aggregated feature based on the k^{th} diffusion strength parameter in the diffusion strength parameter sequence through the depth completion network to obtain a k^{th}-round depth completion feature; and
wherein the processor is further configured to execute the computer-readable instructions to perform image restoration based on the depth completion feature to obtain the dense depth map by:
performing image restoration based on the k^{th}-round depth completion feature to obtain the k^{th}-round dense depth map.

16. The apparatus according to claim 13, wherein the depth completion network comprises a downsampling diffusion subnetwork and an upsampling diffusion subnetwork, and
wherein the processor is further configured to execute the computer-readable instructions to diffuse and complete the aggregated feature based on the diffusion strength parameter by:
performing downsampling diffusion on the aggregated feature based on the diffusion strength parameter through the downsampling diffusion subnetwork to obtain a downsampling depth feature; and
performing upsampling diffusion on the downsampling depth feature based on the diffusion strength parameter through the upsampling diffusion subnetwork to obtain the depth completion feature.

17. The apparatus according to claim 16,
wherein the downsampling diffusion subnetwork comprises n downsampling layers, and the upsampling diffusion subnetwork comprises n upsampling layers, n being a positive integer,
wherein the processor is further configured to execute the computer-readable instructions to perform downsampling diffusion on the aggregated feature by:
performing downsampling diffusion on the aggregated feature based on the diffusion strength parameter through a first downsampling layer to obtain a first downsampling feature;
performing downsampling diffusion on an i^{th} downsampling feature based on the diffusion strength parameter through an (i+1)^{th} downsampling layer to obtain an (i+1)^{th} downsampling feature, i being a positive integer; and
using an n^{th} downsampling feature outputted by an n^{th} downsampling layer as the downsampling depth feature; and
wherein the processor is further configured to execute the computer-readable instructions to perform upsampling diffusion on the downsampling depth feature by:
performing upsampling diffusion on the downsampling depth feature based on the diffusion strength parameter through a first upsampling layer to obtain a first upsampling feature;
performing upsampling diffusion on an i^{th} upsampling feature based on the diffusion strength parameter through an (i+1)^{th} upsampling layer to obtain an (i+1)^{th} upsampling feature; and
using an n^{th} upsampling feature outputted by an n^{th} upsampling layer as the depth completion feature.

18. The apparatus according to claim 17,
wherein the processor is further configured to execute the computer-readable instructions to perform downsampling diffusion on the i^{th} downsampling feature based on the diffusion strength parameter through the (i+1)^{th} downsampling layer to obtain the (i+1)^{th} downsampling feature by:
performing downsampling on the i^{th} downsampling feature to obtain a downsampling intermediate feature;
fusing a diffusion strength feature and the downsampling intermediate feature to generate a downsampling fused feature, the diffusion strength feature being obtained based on feature extraction on the diffusion strength parameter; and
fusing the downsampling intermediate feature and the downsampling fused feature to generate the (i+1)^{th} downsampling feature.

19. The apparatus according to claim 13,
wherein the processor is further configured to execute the computer-readable instructions to aggregate the features of the scene image and the sparse depth map to obtain the aggregated feature, by:
encoding a feature of the sparse depth map through a first encoder to obtain a sparse depth feature;
encoding a feature of the scene image through a second encoder to obtain a scene feature; and
aggregating the scene feature and the sparse depth features, and performing noise addition processing through the noise to obtain the aggregated feature, dimensions of the scene feature, the sparse depth feature, and the noise being consistent.

20. A non-transitory computer-readable storage medium, having at least one computer instruction stored therein, the at least one computer instruction, when executed by a processor, causes the processor to implement the depth map completion method according to claim 1.
